(19) United States
(12) Patent Application Publication
(10) Pub. No.: US 2011/0245394 A1
(43) Pub. Date: Oct. 6, 2011

(54) AROMATIC POLYSULFONE RESIN COMPOSITION AND MOLDED ARTICLE THEREOF

(75) Inventors: Shintaro SAITO, Tsukuba-shi (JP); Mitsuo MAEDA, Tsukuba-shi (JP)

(73) Assignee: SUMITOMO CHEMICAL COMPANY, LIMITED, Tokyo (JP)

(21) Appl. No.: 13/070,866

(22) Filed: Mar. 24, 2011

(30) Foreign Application Priority Data
Mar. 30, 2010 (JP) 2010-077184

(51) Int. Cl. C08K 5/103; C08L 81/06; B29C 45/00

(52) U.S. Cl. 524/310; 524/317; 524/312; 524/313; 264/328.1

(57) ABSTRACT

An aromatic polysulfone resin composition including an aromatic polysulfone resin and at least one compound selected from the group consisting of a monoacylglycerol, a diacylglycerol and a triacylglycerol, wherein the amount of the at least one compound, relative to 100 parts by weight of the aromatic polysulfone resin is preferably 0.02 to 4 parts by weight, and the aromatic polysulfone resin composition is preferably in the form of pellet obtained by subjecting the aromatic polysulfone resin and the at least one compound to melt-kneading.

### TECHNICAL FIELD

The present invention is related to an aromatic polysulfone resin composition and a molded article thereof.

Priority is claimed on Japanese Patent Application No. 2010-077184, filed Mar. 30, 2010, the content of which is incorporated herein by reference.

### Background Art

Aromatic polysulfone resins exhibit excellent mechanical properties, thermal properties and electrical properties. Therefore, aromatic polysulfone resins are preferably used as molding materials for producing mechanical parts, aviation parts and electric/electronic parts. An aromatic polysulfone resins can be molded by extrusion molding, injection molding, compression molding or rotational molding. However, an aromatic polysulfone resin is disadvantageous in that it requires high pressure for molding due to its high melt viscosity, the mold shrinkage factor becomes small due to its amorphous properties, and exhibits a high elasticity. For these reasons, an aromatic polysulfone resin poses a problem that it is difficult to take out the molded article from the mold used for the molding, i.e., an aromatic polysulfone resin has a poor mold releasability.

For solving this problem, addition of a mold release agent to an aromatic polysulfone resin has been considered. For example, Patent Documents 1 and 2 disclose an aromatic polysulfone resin composition obtained by adding a metal soap or a fatty acid (bis)amide to an aromatic polysulfone resin, and Patent Document 3 discloses an aromatic polysulfone resin composition obtained by adding a phenyl ether-type synthetic oil to an aromatic polysulfone resin. Furthermore, Patent Documents 1 to 3 also disclose an aromatic polysulfone resin composition obtained by adding a fatty acid ester, a polyethylene wax or a microglycerine wax to an aromatic polysulfone resin.

### DOCUMENTS OF RELATED ART

### Patent Document

[Patent Document 1] Japanese Unexamined Patent Application, First Publication No. Sho 60-149629

[Patent Document 2 Japanese Unexamined Patent Application, First Publication No. Sho 63-264667

[Patent Document 3 Japanese Unexamined Patent Application, First Publication No. Sho 63-54464

### SUMMARY OF THE INVENTION

The above-mentioned conventional aromatic polysulfone resin compositions did not necessarily have sufficient mold releasability. When the amount of the mold release agent is increased to improve the mold releasability, problems are caused in that the mechanical strength is deteriorated, and the molded article becomes opaque. Furthermore, aromatic polysulfone resins tend to be tinted. Therefore, an aromatic polysulfone resin composition with reduced color has been demanded in order to improve transparency and luster.

The present invention takes the above circumstances into consideration, with an object of providing an aromatic polysulfone resin composition having an excellent mold releasability and reduced color.

For solving the above-mentioned problems, the present invention provides an aromatic polysulfone resin composition including an aromatic polysulfone resin and at least one compound selected from the group consisting of a monoacylglycerol, a diacylglycerol and a triacylglycerol. The present invention also provides a molded article obtained by subjecting the aromatic polysulfone resin composition to injection molding.

The aromatic polysulfone resin composition of the present invention has an excellent mold releasability and reduced color. Therefore, by subjecting the aromatic polysulfone resin composition to injection molding, a molded article having excellent transparency and luster can be produced.

### BRIEF DESCRIPTION OF THE DRAWINGS

FIG. 1 shows a mold used for measuring the mold release resistance in the working examples.

### DETAILED DESCRIPTION OF THE INVENTION

The aromatic polysulfone resin is a polyarylene compound which essentially requires an arylene unit, an ether bond (—O—) and a sulfone bond (—SO₂—), and the arylene unit, the ether bond and the sulfone bond are positioned in order or in disorder.

The aromatic polysulfone resin preferably has a melt viscosity of 200 to 1,000 Pa·s, more preferably 200 to 700 Pa·s, and still more preferably 300 to 500 Pa·s, as measured at 340° C. and a shear rate of 1,000 s⁻¹. When the melt viscosity is too high, the fluidity of the aromatic polysulfone resin composition during molding tends to be deteriorated. On the other hand, when the melt viscosity is too low, the strength of the aromatic polysulfone resin composition tends to be deteriorated.

The aromatic polysulfone resin preferably has a structural unit represented by formula (1) shown below (hereafter, frequently referred to as “structural unit (1)”), and may also have a structural unit represented by formula (2) shown below (hereafter, frequently referred to as “structural unit (2)”) and/or a structural unit represented by formula (3) shown below (hereafter, frequently referred to as “structural unit (3)”).

-Ph¹-SO₂-Ph²-O— (1)

In formula (1), Ph¹ and Ph² each independently represents a group represented by formula (4) shown below.

-Ph³-R-Ph⁴-O— (2)

In formula (2), Ph³ and Ph⁴ each independently represents a group represented by formula (4) shown below, and R represents an alkylidene group of 1 to 5 carbon atoms.

-(Ph⁵)ₙ-O— (3)

In formula (3), Ph⁵ represents a group represented by formula (4) shown below, and n represents an integer of 1 to 3, provided that, when n is 2 or more, the plurality of the Ph⁵ groups may be the same or different from each other.

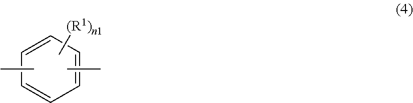

In formula (4), R¹ represents an alkyl group of 1 to 6 carbon atoms, an alkenyl group of 3 to 10 carbon atoms, a phenyl group or a halogen atom, and n1 represents an integer of 0 to 4, provided that, when n1 is 2 or more, the plurality of the R¹ groups may be the same or different from each other.

When the aromatic polysulfone resin has a structural unit (1), in formula (4) represented by Ph¹ and Ph² of formula (1), n1 is preferably 0, and the group represented by formula (4) is preferably a p-phenylene group. Further, the amount of the structural unit (1) based on the total of all structural units constituting the aromatic polysulfone resin is preferably 80 mol % or more.

When the aromatic polysulfone resin has a structural unit (1) and a structural unit (2), in formula (4) represented by Ph¹ and Ph² of formula (1) and Ph³ and Ph⁴ of formula (2), n1 is preferably 0, and the group represented by formula (4) is preferably a p-phenylene group. In formula (2), R is preferably an isopropylidene group. Furthermore, the structural unit (1)/structural unit (2) molar ratio is generally 0.5 to 50, preferably 0.5 to 9, and more preferably 0.5 to 4.

When the aromatic polysulfone resin has a structural unit (1) and a structural unit (3), in formula (4) represented by Ph¹ and Ph² of formula (1) and Ph⁵ of formula (3), n1 is preferably 0, and the group represented by formula (4) is preferably a p-phenylene group. In formula (3), n is preferably 1 or 2. Furthermore, the structural unit (1)/structural unit (3) molar ratio is generally 0.1 to 20, preferably 0.1 to 9, and more preferably 0.5 to 4.

As the aromatic polysulfone resin, a resin consisting essentially of the structural unit (1) or a resin consisting essentially of the structural units (1) and (2) is preferable, and a resin essentially consisting of the structural unit (1) is more preferable.

The aromatic polysulfone resin can be produced by subjecting a corresponding bis(haloaryl)sulfone and a bis(hydroxyaryl) compound to a dehydrohalogenation/polycondensation reaction using a base. Examples of commercially available aromatic polysulfone resins include Sumika Excel PES3600P or Sumika Excel PES4100P (an aromatic polysulfone resin having the structural unit (1)) manufactured by Sumitomo Chemical Company, and UDEL P-1700 (an aromatic polysulfone resin having both the structural unit (1) and the structural unit (2)) manufactured by AMOCO. The terminal group of the aromatic polysulfone resin can be appropriately selected depending on the production method, and examples thereof include a halogen atom, a hydroxyl group and an alkoxyl group.

The aromatic polysulfone resin composition of the present invention includes the aforementioned aromatic polysulfone resin and at least one compound selected from the group consisting of a monoacylglycerol, a diacylglycerol and a triacylglycerol. By blending a specific compound as a mold release agent with an aromatic polysulfone resin, an aromatic polysulfone resin composition with an excellent mold releasability and reduced color can be obtained.

The at least one compound selected from the group consisting of a monoacylglycerol, a diacylglycerol and a triacylglycerol is typically represented by formula (5) shown below.

R²O—CH₂—CH(OR³)—CH₂—OR⁴ (5)

In formula (5), each of R², R³ and R⁴ independently represents a hydrogen atom or a residue of a fatty acid in which the hydroxyl group of the carboxyl group has been removed, provided that at least one of R², R³ and R⁴ represents a residue of a fatty acid in which the hydroxyl group of the carboxyl group has been removed.

The monoacylglycerol is preferably an ester of one molecule of a fatty acid and glycerine, and is typically represented by formula (5′) shown below.

R⁵O—CH₂—CH(OR⁶)—CH₂—OR⁷ (5′)

In formula (5′), each of R⁵, R⁶ and R⁷ independently represents a hydrogen atom or a residue of a fatty acid in which the hydroxyl group of the carboxyl group has been removed, provided that one of R⁵, R⁶ and R⁷ represents a residue of a fatty acid in which the hydroxyl group of the carboxyl group has been removed.

Examples of monoacylglycerols include glycerol monocaprylate, glycerol monoundecanoate, glycerol monolaurate, glycerol monotridecanoate, glycerol monomyristate, glycerol monopentadecanoate, glycerol monopalmitate, glycerol monoheptadecanoate, glycerol monostearate, glycerol mononanodecanoate, glycerol monoarachidate, glycerol monobehenate, glycerol monolignocerate, glycerol monocerotate, glycerol monoheptacosanoate, glycerol monomontanate, glycerol monotriacontanoate and glycerol monodotriacontanoate.

The diacylglycerol is preferably an ester of two same or different molecules of a fatty acid and glycerine, and is typically represented by formula (5″) shown below.

R⁸O—CH₂—CH(OR⁹)—CH₂—OR¹⁰ (5″)

In formula (5″), each of R⁸, R⁹ and R¹⁰ independently represents a hydrogen atom or a residue of a fatty acid in which the hydroxyl group of the carboxyl group has been removed, provided that two of R⁸, R⁹ and R¹⁰ represents a residue of a fatty acid in which the hydroxyl group of the carboxyl group has been removed.

Examples of diacylglycerols include glycerol dicaprylate, glycerol diundecanoate, glycerol dilaurate, glycerol ditridecanoate, glycerol dimyristate, glycerol dipentadecanoate, glycerol dipalmitate, glycerol diheptadecanoate, glycerol distearate, glycerol dinanodecanoate, glycerol diarachidate, glycerol dibehenate, glycerol dilignocerate, glycerol dicerotate, glycerol diheptacosanoate, glycerol dimontanate, glycerol ditriacontanoate and glycerol didotriacontanoate.

The triacylglycerol is preferably an ester of three same or different molecules of a fatty acid and glycerine, and is typically represented by formula (5″′) shown below.

R¹¹O—CH₂—CH(OR¹²)—CH₂—OR¹³ (5″′)

In formula (5″′), each of R¹¹, R¹²and R¹³ independently represents a residue of a fatty acid in which the hydroxyl group of the carboxyl group has been removed.

Examples of triacylglycerols include glycerol tricaprylate, glycerol triundecanoate, glycerol trilaurate, glycerol tritridecanoate, glycerol trimyristate, glycerol tripentadecanoate, glycerol tripalmitate, glycerol triheptadecanoate, glycerol tristearate, glycerol trinanodecanoate, glycerol triarachidate, glycerol tribehenate, glycerol trilignocerate, glycerol tricerotate, glycerol triheptacosanoate, glycerol trimontanate, glycerol tritriacontanoate and glycerol tridotriacontanoate.

Examples of the fatty acid include caprylic acid, undecylic acid, lauric acid, tridecylic acid, myristic acid, pentadecylic acid, palmitic acid, heptadecylic acid, stearic acid, nonadecanoic acid, arachidic acid, behenic acid, lignoceric acid, cerotic acid, heptacosanoic acid, montanoic acid, melissic acid and lacceric acid. The fatty acid preferably has 10 to 30 carbon atoms.

The fatty acid is preferably a saturated fatty acid, and is preferably a linear fatty acid.

As the at least one compound selected from the group consisting of a monoacylglycerol, a diacylglycerol and a triacylglycerol, a triacylglycerol is preferable.

As the at least one compound selected from the group consisting of a monoacylglycerol, a diacylglycerol and a triacylglycerol, a compound having a small particle diameter, more specifically, a compound which is capable of passing through a 100 mesh sieve is preferable. If the particle diameter is too large, the at least one compound selected from the group consisting of a monoacylglycerol, a diacylglycerol and a triacylglycerol is likely to be susceptible to high shear force, and decomposition thereof is promoted. As a result, the obtained aromatic polysulfone resin composition and the molded article thereof are likely to be harmfully affected.

The amount of the at least one compound selected from the group consisting of a monoacylglycerol, a diacylglycerol and a triacylglycerol, relative to 100 parts by weight of the aromatic polysulfone resin is preferably 0.02 to 4 parts by weight, more preferably 0.03 to 2 parts by weight, and still more preferably 0.05 to 1 part by weight. When the amount of the at least one compound selected from the group consisting of a monoacylglycerol, a diacylglycerol and a triacylglycerol is too small, the mold releasability becomes insufficient. On the other hand, when the amount of the at least one compound is too large, although the mold releasability is improved, disadvantages are caused in that fuming is likely to occur, the mold surface is likely to be contaminated and the molded article is likely to become opaque.

In the aromatic polysulfone resin composition of the present invention, if desired, at least one component other than the aromatic polysulfone resin and the at least one compound selected from the group consisting of a monoacylglycerol, a diacylglycerol and a triacylglycerol can be added, for example, a fibrous or acicular reinforcing material such as an aluminum fiber, a glass fiber, a silica alumina fiber, an alumina fiber, a carbon fiber or an aluminum borate whisker; a powder such as an aluminum powder or an aluminum flake; an inorganic filler such as mica or glass beads; a mold release agent other than the at least one compound selected from the group consisting of a monoacylglycerol, a diacylglycerol, such as a fluorine resin or a metal soap; a colorant such as a pigment (e.g., titanium oxide) or a dye; an antioxidant; a thermal stabilizer; an ultraviolet absorber; an antistatic agent; and a surfactant. Among these examples, when the aromatic polysulfone resin composition contains a fibrous or acicular reinforcing material or an inorganic filler, the mold shrinkage is improved, and the mold releasability is enhanced. Therefore, the effects of the present invention becomes significant when the aromatic polysulfone resin composition does not contain the reinforcing material or the filler.

The aromatic polysulfone resin composition of the present invention can be preferably produced by subjecting the aromatic polysulfone resin and the at least one compound selected from the group consisting of a monoacylglycerol, a diacylglycerol and a triacylglycerol to melt-kneading, thereby obtaining the aromatic polysulfone resin composition in the form of a pellet. Typically, the aromatic polysulfone resin composition can be produced by mixing together an aromatic polysulfone resin, at least one compound selected from the group consisting of a monoacylglycerol, a diacylglycerol and a triacylglycerol and any other component if desired by using a Henschel mixer or a ribbon blender, followed by melt-kneading by a single-screw extruder or a twin-screw extruder generally at 250 to 400° C., preferably 300 to 390° C., thereby obtaining the aromatic polysulfone resin composition in the form of a pellet.

Alternatively, an aromatic polysulfone resin in the form of a pellet can be mixed with at least one compound selected from the group consisting of a monoacylglycerol, a diacylglycerol and a triacylglycerol using a tumbler mixer or the like, and the obtained mixture may be subjected to molding. In such a case, by melt-kneading in a molding machine, a uniform aromatic polysulfone resin composition can be obtained. As such, the at least one compound selected from the group consisting of a monoacylglycerol, a diacylglycerol and a triacylglycerol can be blended at any time before molding. However, in terms of reducing the color of the aromatic polysulfone resin, as described above, it is preferable to subjecting the aromatic polysulfone resin and the at least one compound selected from the group consisting of a monoacylglycerol, a diacylglycerol and a triacylglycerol to melt-kneading, thereby obtaining the aromatic polysulfone resin composition in the form of a pellet, and then subjecting the obtained pellet to molding.

The aromatic polysulfone resin composition can be molded into various parts and members, and examples of the molding method include injection molding, compression molding, extrusion molding and blow molding. Among these, injection molding is preferable.

Examples of the molded article include electric and electronic parts, such as a connector, a socket, a relay part, a coil bobbin, an optical pick-up, a radiator, a printed wiring board and computer associated parts; semiconductor production process associated parts, such as an IC tray and a wafer carrier; household electrical appliance parts, such as a VTR, a television, an iron, an air conditioner, a stereo, a vacuum cleaner, a refrigerator, a rice cooker and lighting; lighting parts, such as a lamp reflector and a lamp holder; acoustic product parts, such as a compact disc, a laser disc (registered trademark) and a speaker; communication equipment parts, such as a ferrule for an optical cable, a telephone part, a facsimile part and a modem; copying machine associated parts, such as a claw separation and a heat holder; mechanical parts, such as an impeller, a fan, a toothed wheel, a gear, a bearing, and a motor part and a case thereof; vehicle parts, such as a vehicle mechanism part, an engine part, an engine room interior part, electric equipment parts and interior parts; cookware, such as a microwave cooking pot and a thermal resistant plate; constructional materials or civil engineering materials, such as a flooring material, a thermal insulant or sound-proof material for a wall material, a support material such as a beam or a piller and a roof material; air craft parts; space craft parts; parts for a radiation facility such as a nuclear reactor; parts for an oceanic facility; a washing jig; optical appliance parts; valves; pipes; nozzles; filters; membranes; medical appliance parts and medical materials; parts for sensors; sanitary equipments; sports goods; and leisure goods.

Even when the aromatic polysulfone resin composition of the present invention is molded to a size having a minimum thickness of no more than 3.0 mm, especially no more than 2.0 mm, the aromatic polysulfone resin composition can maintain about the same level of strength as an aromatic polysulfone resin by itself while improving the mold releasability. As a result, a thin molded article can be stably obtained without deforming or breaking the molded article when it is released from the mold. Therefore, the aromatic polysulfone resin composition of the present invention can be preferably used as a molded material for manufacturing a lamp reflector which requires not only reduction in thickness, increase in size and fluidity during molding, but also thermal resistance and strength. Examples of the lamp reflector include a reflector for a head lamp of a vehicle, a reflector for a fog lamp and a sub-reflector for a head lamp.

### EXAMPLES

As follows is a description of examples of the present invention, although the scope of the present invention is by no way limited by these examples.

### Examples 1 to 5, Comparative Examples 1 to 6

As an aromatic polysulfone resin, Sumika Excel PES3600P (resin (1)) or Sumika Excel PES4100P (resin (2)) manufactured by Sumitomo Chemical Company was used. As a mold release agent, one of the following was used.

Mold release agent (1): tristearoyl glycerol (product name: MOLDWIZ INT-40DHT; manufactured by AXEL PLASTICS RESEARCH LABORATORIES)

Mold release agent (2): glycerol trimyristate (manufactured by MP Biomedicals, Inc.)

Mold release agent (3): glycerol monostearate (manufactured by Wako Chemical, Ltd)

Mold release agent (4): glycerol distearate (manufactured by Wako Chemical, Ltd)

Mold release agent (5): dipentaerythritol hexastearate (product name: LOXIOL VPG2571; manufactured by Cognis-Oleochemicals Japan

Mold release agent (6): barium stearate (product name: SB; manufactured by Sakai Chemical Industry Co. Ltd.)

To 100 parts by weight of an aromatic polysulfone resin was added a mold release agent in an amount shown in Table 1, and was then dry-blended by a Henschel mixer. The obtained mixture was charged into a twin-screw extruder (product name: PCM-30; manufactured by Ikegai Co., Ltd.) and pelletized at a cylinder temperature of 330 to 350° C., thereby obtaining a pellet of an aromatic polysulfone resin (Comparative Examples 1 and 6) or composition thereof (Examples 1 to 5 and Comparative Examples 2 to 5). With respect to the obtained pellet, the mold release resistance, the tensile strength and the color were evaluated as follows. The results are shown in Table 1.

[Measurement of Mold Release Resistance]

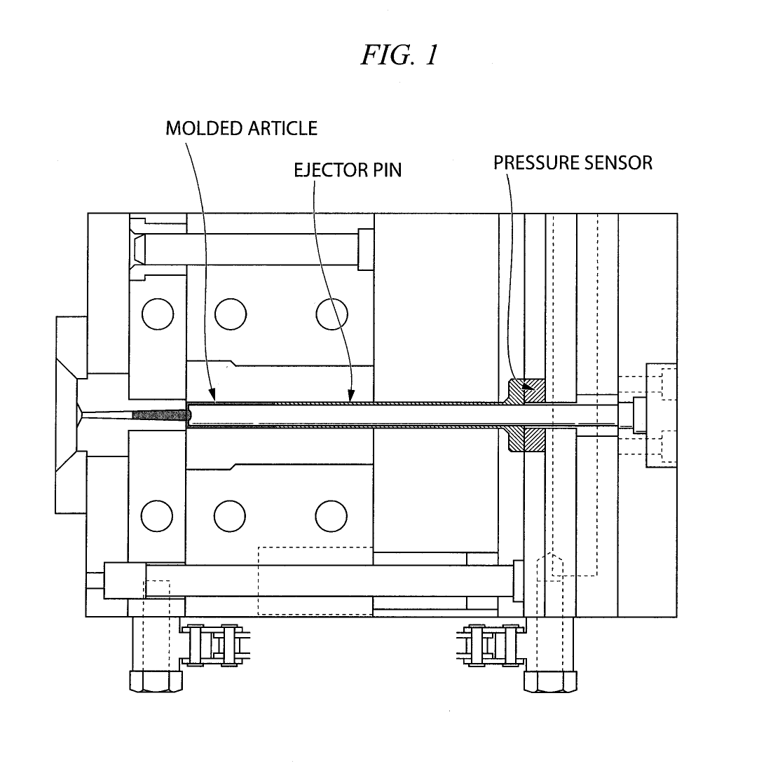

The pellet was injected into a mold shown in FIG. 1, using an injection molding machine (product name: ES-400; manufactured by NISSEI PLASTIC INDUSTRIAL CO., LTD.) at a cylinder temperature of 360° C., a mold temperature of 150° C., a holding pressure of 900kg/cm² or 1300kg/cm² and a constant injection rate. Then, the pressure required to take the molded article (φ11×φ15×10 mm, both the core and the cavity excluded, 0 taper) out of the mold was measured, and this pressure was defined as the mole release resistance.

[Measurement of Tensile Strength]

Using an injection molding machine, the pellet was molded into a dumbbell specimen (ASTM No. 4), and the tensile strength was measured in accordance with ASTMD638.

[Evaluation of Color]

Using an injection molding machine, the pellet was molded into a plate specimen (64mm×64mm×3mm) using a mold polished with #4000. With respect to the obtained plate specimen, the cloudiness of the color was evaluated by visual observation. With respect to a plate specimen which was not opaque, the light transmittance in terms of the L value and the YI value were measured using a colormeter (product name: ZE-2000; manufactured by NIPPON DENSHOKU INDUSTRIES CO., LTD.).

TABLE 1

| | | Example | | | | | |
|---|---|---|---|---|---|---|---|
| | | Ex. 1 | Ex. 2 | Ex. 3 | Ex. 4 | Ex. 5 | Ex. 6 |
| Resin (1) (Parts by weight) | | 100 | 100 | 0 | 0 | 0 | 0 |
| Resin (2) (Parts by weight) | | 0 | 0 | 100 | 100 | 100 | 100 |
| Mold release agent (1) | | 0.1 | 0.5 | 0.1 | 0 | 0 | 0 |
| (Parts by weight) | | | | | | | |
| Mold release agent (2) | | 0 | 0 | 0 | 0.1 | 0 | 0 |
| (Parts by weight) | | | | | | | |
| Mold release agent (3) | | 0 | 0 | 0 | 0 | 0.1 | 0 |
| (Parts by weight) | | | | | | | |
| Mold release agent (4) | | 0 | 0 | 0 | 0 | 0 | 0.1 |
| (Parts by weight) | | | | | | | |
| Mold | Holding pressure | 17 | 10 | 22 | 34 | 42 | 35 |
| release | 900 kg/cm² | | | | | | |
| resistance | Holding pressure | 127 | 46 | 60 | 76 | 62 | 79 |
| (kg/cm²) | 1300 kg/cm² | | | | | | |
| Tensile | Strength (MPa) | 87 | 87 | 90 | 87 | 87 | 88 |
| | Elongation (%) | 66 | 70 | 60 | 67 | 68 | 63 |
| Color | L | 87 | 87 | 87 | 85 | 87 | 87 |
| | YI | 17 | 17 | 16 | 20 | 16 | 16 |

| | | Example | | | | | |
|---|---|---|---|---|---|---|---|
| | | Comp. | Comp. | Comp. | Comp. | Comp. | Comp. |
| | | Ex. 1 | Ex. 6 | Ex. 2 | Ex. 3 | Ex. 4 | Ex. 5 |
| Resin (1) (Parts by weight) | | 100 | 100 | 100 | 100 | 100 | 100 |
| Resin (2) (Parts by weight) | | 0 | 0 | 0 | 0 | 0 | 0 |
| Mold release agent (1) | | 0 | 0 | 0 | 0 | 0 | 0 |
| (Parts by weight) | | | | | | | |
| Mold release agent (2) | | 0 | 0 | 0 | 0 | 0 | 0 |
| (Parts by weight) | | | | | | | |
| Mold release agent (3) | | 0 | 0 | 0 | 0 | 0 | 0 |
| (Parts by weight) | | | | | | | |
| Mold release agent (4) | | 0 | 0 | 0 | 0 | 0 | 0 |
| (Parts by weight) | | | | | | | |
| Mold release agent (5) | | 0 | 0 | 0.1 | 0 | 5 | 0 |
| (Parts by weight) | | | | | | | |
| Mold release agent (6) | | 0 | 0 | 0 | 0.1 | 0 | 5 |
| (Parts by weight) | | | | | | | |
| Mold | Holding pressure | 40 | 43 | 50 | 39 | — | — |
| release | 900 kg/cm² | | | | | | |
| resistance | Holding pressure | 233 | 140 | 248 | 130 | | |
| (kg/cm²) | 1300 kg/cm² | | | | | | |
| Tensile | Strength (MPa) | 86 | 86 | 86 | 86 | — | — |
| | Elongation (%) | 55 | 52 | 39 | 60 | | |
| Color | L | 85 | 84 | 66 | 86 | Opaque | Opaque |
| | YI | 19 | 22 | 62 | 19 | | |

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An aromatic polysulfone resin composition comprising an aromatic polysulfone resin and at least one compound selected from the group consisting of a monoacylglycerol, a diacylglycerol and a triacylglycerol.

2. The aromatic polysulfone resin composition according to claim 1, wherein the amount of the at least one compound selected from the group consisting of a monoacylglycerol, a diacylglycerol and a triacylglycerol, relative to 100 parts by weight of the aromatic polysulfone resin is 0.02 to 4 parts by weight.

3. The aromatic polysulfone resin composition according to claim 1, wherein the or each acyl group of the at least one compound selected from the group consisting of a monoacylglycerol, a diacylglycerol and a triacylglycerol is independently a residue of a fatty acid of 10 to 30 carbon atoms in which the hydroxyl group of the carboxyl group has been removed.

4. The aromatic polysulfone resin composition according to claim 1, wherein the at least one compound selected from the group consisting of a monoacylglycerol, a diacylglycerol and a triacylglycerol is a triacylglycerol.

5. The aromatic polysulfone resin composition according to claim 4, wherein the amount of the triacylglycerol, relative to 100 parts by weight of the aromatic polysulfone resin is 0.02 to 4 parts by weight.

6. The aromatic polysulfone resin composition according to claim 4, wherein the three acyl groups of the triacylglycerol each independently is a residue of a fatty acid of 10 to 30 carbon atoms in which the hydroxyl group of the carboxyl group has been removed.

7. The aromatic polysulfone resin composition according to claim 1, which is in the form of pellet obtained by subjecting the aromatic polysulfone resin and the triacylglycerol to melt-kneading.

8. The aromatic polysulfone resin composition according to claim 1, wherein the aromatic polysulfone resin has a melt viscosity of 200 to 1,000 Pa·s, as measured at 340° C. and a shear rate of 1,000 s⁻¹.

9. A molded article obtainable by subjecting the aromatic polysulfone resin composition of claim 1 to injection molding.
